(19) United States
(12) Patent Application Publication
(10) Pub. No.: US 2011/0038094 A1
(43) Pub. Date: Feb. 17, 2011

(54) CAPACITOR

(75) Inventors: Kaoru Mori, Tokyo (JP); Takashi Nakagawa, Tokyo (JP)

Correspondence Address: YOUNG & THOMPSON, 209 Madison Street, Suite 500, Alexandria, VA, 22314, US

(73) Assignee: RENESAS ELECTRONICS CORPORATION, Kawasaki-shi, Kanagawa (JP)

(21) Appl. No.: 12/937,916

(22) PCT Filed: Apr. 16, 2009
(86) PCT No.: PCT/JP2009/057696

§ 371 Date: Oct. 14, 2010

(30) Foreign Application Priority Data
Apr. 16, 2008 (JP) 2008-106422

(51) Int. Cl. H01G 4/008; H01G 4/00

(52) U.S. Cl. 361/305; 427/80

(57) ABSTRACT

A capacitor includes a plurality of laminated thin layers, has a structure in which a lower electrode layer, a dielectric layer and an upper electrode layer are laminated in sequence, a main material of the lower electrode layer is TiN or ZrN, the lower electrode layer contains oxygen, and concentration of the oxygen contained in the lower electrode layer is less than 21 at %.

### TECHNICAL FIELD

The present invention relates a capacitor that includes a laminated thin-film structure in which a dielectric layer is sandwiched above and below by an electrode layer. More specifically, it relates to a capacitor that includes a laminated thin-film structure in which a dielectric layer is sandwiched above and below by an electrode layer, and in which the electrode layer contains oxygen.

### BACKGROUND ART

In the development of semiconductor devices in which high integration of elements are advanced, miniaturization of each element has progressed. Consequently there is a limitation on the area occupied by a capacitor constituting a memory cell such as a DRAM, and therefore there is a risk that the capacitor will have an insufficient capacity. This is due to the fact that the capacity of a capacitor is proportional to the surface area of the electrode and the relative dielectric constant of the dielectric material, and inversely proportional to the distance between the electrodes. When the capacitor does not have a sufficient capacity, there is a tendency for malfunction result from the decrease in the capacitor charge due to the effect of external noise signals or the like, thereby causing errors, that are typically soft errors. Consequently, in order to realize a required capacitor for memory cells, there is a need to have a high relative dielectric constant and a thin film thickness.

As a means of increasing the capacitor capacity of a DRAM, investigations have been made into using an HfO₂ film, a ZrO₂ film, and an Al₂O₃ film that have a higher relative dielectric constant than an SiO₂ film, an SiN film, or an SiON film combining both of them, as a capacitor insulating film . In recent years, research has been conducted for the purpose of realizing an even higher relative dielectric constant with a thin film thickness in relation to a laminated structure of a HfO₂ film, a ZrO₂ film, and an Al₂O₃ film; or a ZrON film and a HfON film; or a ZrAlO film, a ZrSiO film, a HfAlO film, and a HfSiO film; or a ZrAlON film, a ZrSiON film, a HfAlON film, and a HfSiON film. The ZrON film and the HfON film are capacity insulating films in which HfO₂, a ZrO₂, or Al₂O₃ are partially nitrided. The ZrAlO film, the ZrSiO film, the HfAlO film, and the HfSiO film are capacity insulating films in which HfO₂, a ZrO₂, or Al₂O₃ are doped with a metal element. The ZrAlON film, the ZrSiON film, the HfAlON film, and the HfSiON film are capacity insulating films in which they are further partially nitrided.

For example, Patent document 1 and Patent document 2 disclose a capacity insulating film material in which HfO₂ or a ZrO₂ is doped with a metal element such as aluminum (Al), scandium (Sc), lanthanum (La), and the like. In Patent document 1, doping HfO₂ or ZrO₂ with the above metal elements changes the electron affinity of the dielectric material, and thereby changes the barrier height of the electrons and the barrier height of the holes. Patent document 1 discloses that there is a tendency for formation of amorphous dielectric materials due to the fact that the formation of crystal structure is reduced or eliminated by the presence of the doping metals.

Patent document 3 discloses, as a capacity insulating film, a non-crystalline film that is formed from AlxM(1−x)Oy in which non-crystalline aluminum oxide is included in a crystalline dielectric and that has a composition wherein 0.05<x<0.3 (wherein M denotes the metal which can form a crystalline dielectric such as Hf, Zr or the like). This technique is characterized by preventing insulation damage to a capacity insulating film while maintaining a high relative dielectric constant in a non-crystalline zirconium aluminate.

Non-patent document 1 discloses that when the amorphous ZrO₂-Al₂O₃ film prepared by magnetron sputtering is annealed at 1000° C., a crystalline structure of tetragonal crystals or monoclinic crystals is formed. Non-patent document 1 states that monoclinic crystals are formed when the atomic ratio of Zr to Al is 76 to 24, and tetragonal crystals dominate when the atomic ratio of these is 52 to 48.

On the other hand, as described above, there has been an increasing demand in recent years for reduction of the film thickness of the dielectric layer in order to improve capacitor performance. Consequently there is also a need for a technique of reducing a current leakage. A representative effective technique of reducing a current leakage is disclosed in Patent document 4 which describes a technique of including oxygen in the film of the electrode layer. Patent document 4 describes that oxygen can be prevented from escaping from the dielectric layer by including oxygen in the electrode layer and thereby suppress an increase in current leakages.

A method of forming a thin film, that is to say, a film deposition method will be described. An electrode layer or a dielectric layer can be formed using a PVD (plasma vapor deposition) method, a CVD (chemical vapor deposition) method, an ALD (atomic layer deposition) method or the like. The PVD method is generally termed a sputtering method. The PVD method is a film formation method in which a voltage is applied between a substrate and a sputter gate which are arranged opposed to each other in an Ar atmosphere to create a plasma discharge and thereby form a thin film having a principal component of the sputter gate material on the substrate. The PVD method is characterized by high throughput and obtains a thin film with low levels of impurities such as carbon or the like in the film. The CVD method and ALD method are deposition methods in which an oxidizing agent or a nitriding agent is introduced together with a metal material, and undergoes a chemical reaction on the substrate due to application of energy by heating or plasma or the like to thereby form a thin film. The CVD method and ALD method are characterized by creation of a thin film that has excellent step coverage. The CVD method continuously causes a chemical reaction by simultaneous introduction of the synthetic materials of plural kinds. The ALD method does not introduce the synthetic materials simultaneously and forms a thin film while continuously causing a chemical reaction in respective atomic layers by alternately repeating introduction of the metallic material and introduction of the oxidizing agent or the nitriding agent sandwiched by a discharge or purging processing. In the ALD method, there is a low level of impurities such as carbon in the film, and a thin film with excellent step coverage can be obtained. The film formation sequence of alternate repetition of introduction and discharge of specific synthetic materials in an ALD method is termed an ALD cycle.

### Prior Art Documents

### [Patent Documents]

[Patent document 1] Japanese Unexamined Patent Application, First Publication No. 2002-033320

[Patent document 2] Japanese Unexamined Patent Application, First Publication No. 2001-077111

[Patent document 3] Japanese Unexamined Patent Application, First Publication No. 2004-214304

[Patent document 4] Japanese Unexamined Patent Application, First Publication No. H11-040778

[Non-patent document]

[Non-patent document 1] PHYSICAL REVIEW B 39-9, p.6234-6237 (1989).

### SUMMARY OF THE INVENTION

### Problem to be Solved by the Invention

Patent document 4 discloses that the current leakage is lower when an electrode layer has a structure including oxygen than when that has a structure not including oxygen. However Patent document 4 does not include teaching related to the upper limit for the oxygen concentration contained in the electrode layer. The dielectric layer is directly formed on an upper portion of the lower electrode layer, and therefore the lower electrode layer is already formed directly below when forming the dielectric layer. Consequently when the oxygen concentration contained in the lower electrode layer exceeds a suitable value, the lower electrode layer acts as an oxygen supply source when the dielectric layer is formed on an upper portion of the lower electrode layer. Therefore the further problem arises that the conditions for formation of the dielectric layer are substantially different from desired conditions, and the relative dielectric constant of the dielectric layer is reduced.

The present invention has been conceived to solve the above problems, and has an object thereof is to provide a capacitor that effectively reduces the current leakage without reducing the relative dielectric constant of the capacitor.

Hf, Zr and Al that are metals that constitute a dielectric material of a high relative dielectric constant described as related techniques above, and since they are elements that have low electro-negativity and have a property that facilitates binding with oxygen, they are considered to be particularly susceptible to this type of problem. In recent years, an ALD method or film deposition method termed an atomic layer deposition method is commonly used as a method of forming a high-quality dielectric layer of a capacitor. These film deposition methods are characterized by repeating a metal material introduction step and an oxidation step for respective atom layers, and therefore require extremely precise control of formation conditions. Consequently these film deposition methods are susceptible to a problem to be solved by the present invention.

### Means for Solving the Problem

A capacitor according to the present invention has a laminated thin film structure in which a lower electrode layer, a dielectric layer and an upper electrode layer are laminated in sequence, a main material of the lower electrode layer is TiN or ZrN, and the lower electrode layer contains oxygen, and a range of concentration of the oxygen contained in the lower electrode layer is set to a suitable value as disclosed by the present invention.

More precisely, the concentration of the oxygen contained in the lower electrode layer is characterized by less than 21 at %.

In the capacitor according to the present invention, the concentration of the oxygen contained in the lower electrode layer may be less than or equal to 16 at %.

In the capacitor according to the present invention, the concentration of the oxygen contained in the lower electrode layer may be less than or equal to 15 at %.

In the capacitor according to the present invention, the concentration of the oxygen contained in the lower electrode layer may be less than or equal to 12 at %.

In the capacitor according to the present invention, the concentration of the oxygen contained in the lower electrode layer may be less than or equal to 6 at %.

In the capacitor according to the present invention, the main material of the lower electrode layer may be TiN.

In the capacitor according to the present invention, a main material of the dielectric layer may be any one of ZrO₂, HfO₂, Al₂O₃, ZrAlO, ZrSiO, HfAlO, HfSiO, ZrON, HfON, ZrAlON, ZrSiON, HfAlON, and HfSiON.

In the capacitor according to the present invention, a main material of the dielectric layer may be ZrO₂.

In the capacitor according to the present invention, the dielectric layer may be formed by an atomic layer deposition method.

### Effect of the Invention

According to the present invention, a current leakage may be effectively reduced without reducing the relative dielectric constant of the capacitor.

### BRIEF DESCRIPTION OF THE DRAWINGS

FIG. 1 shows a sectional structure of a capacitor according to an embodiment of the present invention.

FIG. 2 shows a sectional structure of a capacitor according to an example of the present invention.

FIG. 3 shows oxygen concentration contained in a film of a lower electrode layer in the capacitor according to the example of the present invention.

FIG. 4 shows a correlation between oxygen concentration contained in the film of the lower electrode layer and the relative dielectric constant of the capacitor according to the example of the present invention.

### EMBODIMENTS FOR CARRYING OUT THE INVENTION

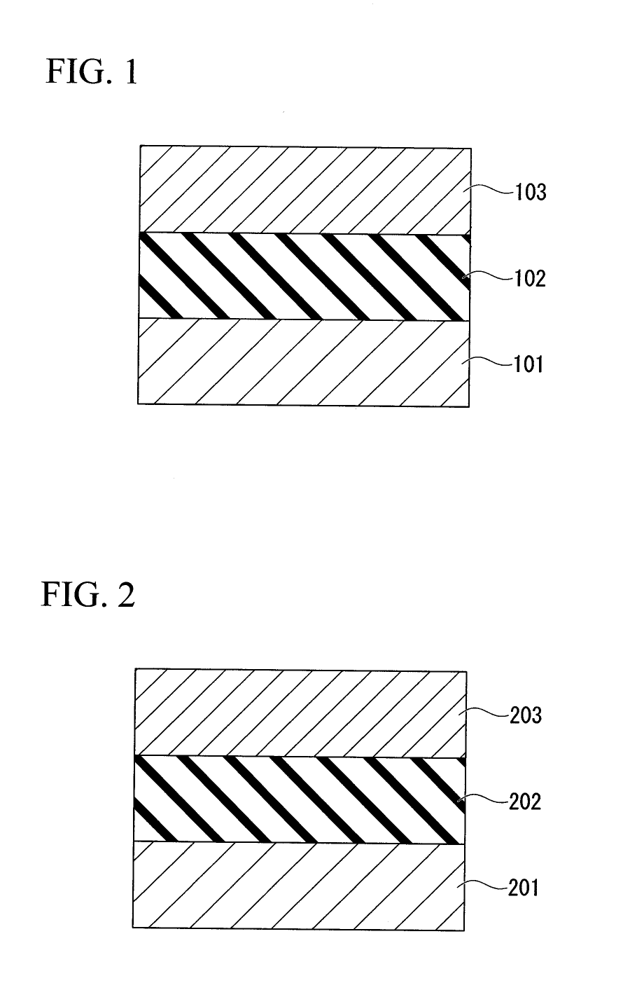

FIG. 1 is a sectional diagram of a capacitor according to an embodiment of the present invention.

The structure of the capacitor according to the embodiment of the present invention will be described with reference to the drawings. As shown in FIG. 1, the capacitor according to the embodiment of the present invention has a capacitor structure in which a lower electrode layer 101, a dielectric layer 102 and an upper electrode layer 103 are sequentially laminated from a substrate side. The main material of the lower electrode layer 101 is TiN or ZrN. The film of the lower electrode layer 101 contains oxygen within a suitable concentration range. More specifically, the effect of this embodiment of the present invention is obtained when the oxygen concentration contained in the lower electrode layer 101 is less than 21 at % (atomic concentration). A correspondingly larger effect is obtained when the oxygen concentration contained in the lower electrode layer 101 is in the range of less than or equal to 16 at %, less than or equal to 15 at %, less than or equal to 12 at %, or less than or equal to 6 at %. The effect of the embodiment of the present invention is obtained independently of the material of the dielectric layer 102. However it is preferred that a main material of the dielectric layer 102 is ZrO₂, HfO₂, Al₂O₃, ZrAlO, ZrSiO, HfAlO, HfSiO, ZrON, HfON, ZrAlON, ZrSiON, HfAlON or HfSiON since a particularly large effect is obtained. Moreover, the effect of the embodiment of the present invention is obtained without particular limitation in relation to the material of the upper electrode layer 103. However it is preferred that the upper electrode layer 103 has a structure of including oxygen in the film since the effect of the decrease in current leakage is decreased as described in Patent document 4.

Next, a method of preparing a capacitor according to the embodiment of the present invention will be described with reference to the drawings.

Firstly a lower electrode layer 101 is deposited on a substrate (not shown). Use of a nitrate conductor, typically TiN or ZrN, that has a high oxygen storage capacity facilitates enablement of this embodiment of the present invention when used as the material for the lower electrode layer 101. The lower electrode layer 101 can be formed using a deposition method such as a PVD method, or a CVD method, or an ALD method. When the lower electrode layer 101 is formed using a PVD method, it is preferred that reactive sputtering is used with a Ti or Zr sputter gate in a mixed atmosphere of Ar and nitrogen. When the lower electrode layer 101 is formed using a CVD method or an ALD method, it is preferred that, for example when using TiN as a main constituent material, TiCl₄ and NH₃ are supplied as synthetic materials, and undergo a chemical reaction on the substrate to which energy is applied by heating or plasma or the like.

During or after formation of the lower electrode layer 101, processing is executed to cause oxygen of a target concentration to be contained in the film of the lower electrode layer 101. More specifically, as a process of causing oxygen to be contained during formation of the lower electrode layer 101, a process of forming the lower electrode layer 101 using sputtering in an atmosphere containing oxygen, a process of forming the lower electrode layer 101 by CVD in an atmosphere containing water vapor, a process of forming the lower electrode layer 101 using ALD including a step of introducing water vapor in the film deposition sequence, and the like can be used. As a process of causing oxygen to be contained after formation of the lower electrode layer 101, a plasma process in an oxygen-containing atmosphere, a process of heating in an atmosphere containing water vapor, and the like. This embodiment of the present invention can be implemented by any of these processes, and oxygen contained in the film of the lower electrode layer 101 can be adjusted to the target concentration by controlling the processing conditions. Each processing method is associated with a different ease of control of the oxygen content, a different maximum value for the oxygen concentration that can be created in the film, a different processing time, and different costs. The characteristics of those respective processing methods will be described below.

Firstly, the process of forming the lower electrode layer 101 by sputtering in an oxygen-containing atmosphere will be described. This process executes sputtering film deposition in a mixed atmosphere containing oxygen. During this process, when TiN for example is used as a main material, a voltage is applied between a Ti sputtering target and a substrate in a mixed atmosphere including oxygen together with Ar and nitrogen to thereby produce a plasma discharge and cause reactive sputtering. In a process of forming a lower electrode layer 101 by sputtering in an atmosphere containing oxygen, it is possible to control the oxygen concentration contained in the lower electrode layer 101 by control of the oxygen partial pressure in the mixed atmosphere containing oxygen, the pressure of the mixed atmosphere containing oxygen, the voltage applied between the sputtering target and the substrate, and the distance between the sputtering target and the substrate. In this process, the oxygen concentration contained into the lower electrode layer 101 can be increased by increasing the partial oxygen pressure in the mixed atmosphere containing oxygen. Even when the partial oxygen pressure in the mixed atmosphere containing oxygen is the same, when the pressure of the mixed atmosphere containing oxygen, the voltage applied between the sputtering target and the substrate, and the distance between the sputtering target and the substrate are different, the oxygen concentration contained in the lower electrode layer 101 is different. This processing method is superior in light of the ease of controlling the oxygen content amount, the large maximum amount of the oxygen concentration that can be contained in the lower electrode layer 101 and the short time required for processing. On the other hand, this processing method requires piping facilities, flow amount control facilities, and the like to introduce the oxygen and therefore is associated with higher costs than use of normal sputtering equipment.

Next, a process of forming the lower electrode layer 101 using CVD in an atmosphere containing water vapor will be described. This process forms a CVD deposition film in an atmosphere containing water vapor. When TiN for example is used as the principal material of the lower electrode layer 101, this process also supplies H₂O in addition to TiCl₄ and NH₃ as synthetic materials, and causes a chemical reaction on the substrate to which energy is applied through heating, plasma or the like. In this process, each supplied raw material is respectively placed in a gaseous state by a vaporization apparatus and introduced into a reaction vessel. Thus, the reaction vessel that contains the substrate contains a mixed vapor atmosphere including all raw material components. In this process, the oxygen concentration contained in the lower electrode layer 101 can be controlled by controlling the water vapor partial pressure and the substrate temperature. In this process, the concentration of the oxygen contained in the lower electrode layer 101 can be increased by increasing the water vapor partial pressure and the substrate temperature. This processing method is superior in light of the ease of controlling the oxygen content amount and the large maximum amount of the oxygen concentration that can be contained in the lower electrode layer 101. On the other hand, this processing method requires equipment for supplying H₂O materials, equipment for vaporizing H₂O, piping facilities, and flow amount control facilities to introduce water vapor into the reaction vessel, and therefore is associated with higher costs than use of a normal CVD apparatus.

Next, the process of forming the lower electrode layer 101 using ALD including a water vapor introduction step in the film deposition sequence will be described. This process performs ALD film deposition in an ALD cycle configured by a film deposition sequence including a water vapor introduction step. In this process, when for example, TiN is used as the principal material of the lower electrode layer 101, the ALD film deposition is performed by an ALD cycle which repeats, as a single cycle, a film deposition sequence executing in sequence a TiCl₄ vapor introduction step, a TiCl₄ vapor discharge step, an NH₃ vapor introduction step, an NH₃ vapor discharge step, a TiCl₄ vapor introduction step, a TiCl₄ vapor discharge step, a water vapor introduction step, and a water vapor discharge step. In this process, when TiN is used as a principal material of the lower electrode layer 101, the oxygen concentration contained in the lower electrode layer 101 can be controlled by controlling: the partial pressure of the introduced water vapor; the partial pressure of the introduced TiCl₄ vapor; the partial pressure of the introduced NH₃ vapor; the proportion of the number of the water vapor introduction steps relative to the number of the raw-material vapor introduction steps in a single cycle; and the substrate temperature. In this process, when TiN is used as a principal material of the lower electrode layer 101, the oxygen concentration contained in the lower electrode layer 101 can be increased by increasing the partial pressure of the introduced water vapor, decreasing the partial pressure of the introduced TiCl₄ vapor or the partial pressure of the introduced NH₃ vapor, or increasing the number of the water vapor introduction steps relative to the number of the raw-material vapor introduction steps in a single cycle. This processing method is superior in that there is a large maximum value for the oxygen concentration that can be contained in the lower electrode layer 101, and in that control of the oxygen content amount is extremely accurate. On the other hand, this processing method is associated with higher costs than use of a normal ALD apparatus due to the requirement for equipment for supplying H₂O materials, equipment for vaporizing H₂O, and piping facilities and flow amount control facilities to introduce water vapor into the reaction vessel. Furthermore since time is required for the discharge steps for raw materials and water vapor, the time required for this process is relatively long.

Next, plasma processing in an atmosphere containing oxygen will be described. After the formation of the lower electrode layer 101, this process generates a plasma discharge in the mixed atmosphere containing oxygen, and maintains the substrate in a stationary manner in the plasma. During this process, for example, plasma irradiation is executed in a mixed atmosphere containing oxygen as well as Ar. For example, when TiN is used as the principal material of the lower electrode layer 101, the mixed atmosphere may be a mixed atmosphere containing oxygen as well as Ar and nitrogen. This process controls the oxygen concentration contained in the lower electrode layer 101 by controlling the oxygen partial pressure in the mixed atmosphere containing oxygen, the pressure of the mixed atmosphere containing oxygen, the voltage of the plasma discharge, and the distance between the plasma discharge source and the substrate. In this process, the oxygen concentration contained in the lower electrode layer 101 can be increased by increasing the partial pressure of oxygen in the mixed atmosphere containing oxygen, increasing the voltage of the plasma discharge, or reducing the distance between the plasma discharge source and the substrate. This processing method is superior in light of the ease of control of the oxygen content amount, a relatively low cost associated with processing, and a short time associated with processing. This process is also superior due to the fact that oxygen at a target concentration is contained in the film of the lower electrode layer 101 independently of the particular film deposition method for forming the lower electrode layer 101.

Finally, the heat process in the atmosphere containing water vapor will be described. After forming the lower electrode layer 101, this process maintains the substrate in a stationary manner while maintaining a fixed temperature and a fixed water vapor partial pressure in a gaseous atmosphere in which temperature and water vapor partial pressure are controlled. This process controls the oxygen concentration contained in the lower electrode layer 101 by controlling the processing temperature, the water vapor partial pressure and the processing time. In this process, the oxygen concentration contained in the lower electrode layer 101 can be increased by increasing the temperature, increasing the partial pressure of water vapor, increasing the processing time. When the processing time is increased, this process can be executed at a relatively low temperature near to ambient temperature, and the like. This process has the disadvantage that the maximum value for the oxygen concentration that can be contained in the lower electrode layer 101 is small, and the time required for processing is relatively long. On the other hand, this processing method can be executed using low-cost equipment, or the costs associated with processing are low, and therefore facilitates implement of the embodiment of the present invention to the largest degree. Furthermore this process is superior in light of the fact that oxygen at a target concentration is contained in the film of the lower electrode layer 101 without depending on a particular film deposition method for forming the lower electrode layer 101. The description of various processing methods for causing oxygen of a target concentration to be contained in a film of the lower electrode layer 101 is now completed.

Points to take into consideration when adjusting the target concentration for the oxygen contained in the film of the lower electrode layer 101 by controlling the processing conditions will be described below. The process of causing oxygen to be contained after formation of the lower electrode layer 101 can control the oxygen concentration contained in the film of the lower electrode layer 101 not only by controlling the processing conditions but also by varying the film thickness of the lower electrode layer 101. In this processing, when the processing conditions are the same, the oxygen concentration contained in the film of the lower electrode layer 101 increases as the film thickness of the lower electrode layer 101 is increased. However since the film thickness of the lower electrode layer 101 is a design element that is strongly restricted by the device design, it will often be the case that design changes for the purpose of adjusting the oxygen concentration will in reality not have a large degree of freedom. Actual restrictions on device design include for example configuring the film thickness of the lower electrode layer 101 to function as an electrode, that is to say, a preferred film thickness expressing superior conductivity, superior covering characteristics or embedding characteristics. The details of such a restriction will differ depending on the individual device. Further points to be considered when adjusting the target concentration for oxygen contained in the film of the lower electrode 101 by controlling the processing conditions will be described below. The process of causing oxygen to be contained after formation of the lower electrode layer 101 as described above is characterized in that oxygen can be contained at a target concentration in the film of the lower electrode layer 101 without depending on any film deposition method for forming the lower electrode layer 101. On the other hand, when the film deposition method for forming the lower electrode layer 101 is different, even when the film thickness of the lower electrode layer 101 is the same under the same processing conditions for processing, as a result, it is often the case that the oxygen concentration contained in the lower electrode layer 101 will take different values. In particular, when the film deposition method for forming the lower electrode layer 101 is a CVD method, the oxygen concentration contained in the lower electrode layer 101 under the same processing conditions for processing and the same film thickness of the lower electrode layer 101 will be subject to a large difference depending on the substrate temperature when the lower electrode layer 101 is formed. Furthermore irrespective of the method that is used for formation of the lower electrode layer 101, when the structure of the film deposition chamber or the film deposition conditions is different, there will be a certain difference in the oxygen concentration contained in the lower electrode layer 101 under the same processing conditions for the process used to cause oxygen to be contained after formation of the lower electrode layer 101 and the same film thickness of the lower electrode layer 101. If this embodiment of the present invention is executed using this process, when changing the film deposition method for forming the lower electrode layer 10, this fact suggests that the processing conditions of the process will require modification in order to adjust the oxygen concentration to the same target concentration as before changing. Furthermore at the same time, when there is a restriction on the processing conditions of the process and the film thickness of the lower electrode layer 101, the oxygen concentration included in the lower electrode layer 101 can be adjusted by varying the film deposition method that forms the lower electrode layer 101. This completes the description of the process of causing oxygen to be contained at a target concentration to the film of the lower electrode layer 101.

There is not always a necessity for the lower electrode layer 101 to be directly formed on the substrate. When required, the lower electrode layer 101 may be formed on an upper portion of a buffer layer that increases the adhesion with the substrate, or on an upper portion of another device.

Next, after the process of causing oxygen to be contained at a target concentration in the film of the lower electrode layer 101, a dielectric layer 102 is deposited on an upper portion of the lower electrode layer 101. The dielectric layer 102 can be formed by a film deposition method such as a PVD method, or a CVD method or an ALD method. In view of the covering characteristics on the trench structure of the capacitor, the film deposition method for the dielectric layer 102 is preferably a CVD method or an ALD method. Since it is considered that impurities such as carbon contained in the dielectric layer 102 cause adverse effects on capacitor performance, a PVD method or an ALD method are preferred in light of the film quality of the dielectric layer 102. When both these points are considered, as the film deposition method of the dielectric layer 102, use of an ALD method is the most preferable. As described above, it is preferable that the film thickness of the dielectric layer 102 is as thin as possible. From the point of forming a dielectric layer 102 of a low film thickness with superior control of film thickness, an ALD method is preferred as the film deposition method for the dielectric layer 102. As described above, when the dielectric layer 102 is formed by an ALD method, the maximum effect of this embodiment of the present invention can be expected. When the dielectric layer 102 is formed using a PVD method, it is preferred that, as a sputtering target, Hf, Zr, Al or the like is used which is a metal configuring the material of the dielectric layer 102 as described in the description related to the structure of the capacitor in the embodiment of the present invention. When forming the dielectric layer 102 using a PVD method, for example, the first or the second method below may be used. The first method forms the dielectric layer 102 with a target composition by suitable oxidizing processing or nitride processing after sputter deposition of a thin film of the metal that configures the material of the dielectric layer 102 in an Ar atmosphere. The second method forms the dielectric layer 102 with a target composition by executing reactive sputtering in a mixed atmosphere of oxygen or nitrogen as well as Ar. When the dielectric layer 102 is formed by a CVD method or an ALD method, in the case where an organic complex that includes, as a core, Hf, Zr, Al that are metals configuring the material for the dielectric layer 102, ZrO₂ is used for example, TEMAZ (tetraxis ethil methil amino zirconium), or the like, together with ozone is preferably supplied as a synthetic material, and subjected to a chemical reaction on a substrate to which energy is applied by heating, plasma or the like. In substitution for ozone, H₂O may be supplied as a synthetic material, and subjected to the same chemical reaction. When the target composition for the dielectric layer 102 contains nitrogen in the form of ZrON, separate appropriate nitride processing is required in relation to the dielectric layer 102.

Next, the upper electrode layer 103 on an upper portion of the dielectric layer 102 is deposited, and it is processed to a suitable size using a technique such as etching and photolithography as required, and thereby the capacitor according to the embodiment of the present invention is completed. The upper electrode layer 103 is formed by a film deposition method such as a PVD method, a CVD method, an ALD method, or it may be formed by any other film deposition method. The effect according to the embodiment of the present invention can be obtained even when forming the upper electrode layer 103 using any film deposition method. As described in relation to the structure of the capacitor according to the embodiment of the present invention, in the embodiment of the present invention, a structure in which the film of the upper electrode layer 103 contains oxygen is still further preferred. In this case, it is required to perform a process of causing oxygen to be contained at a target concentration in the film of the upper electrode layer 103 which is similar to a process of containing oxygen to be contained at a target concentration in the film of the lower electrode layer 101. The process of causing oxygen to be contained at a target concentration to the film of the upper electrode layer 103 is not essential in order to achieve the effect of the embodiment of the present invention. Even when this process is not executed, the effect of the embodiment of the present invention can be realized.

### EXAMPLES

Examples of the present invention are described below.

FIG. 2 is a sectional view of a capacitor according to an example of the present invention.

The structure of a capacitor according to the example of the present invention will be described with reference to the drawings. As shown in FIG. 2, a capacitor according to the example of the present invention includes a capacitor structure in which a lower electrode layer 201, a dielectric layer 202 and an upper electrode layer 203 are sequentially laminated from a substrate side. The principal constituent material of the lower electrode layer 201 is TiN. The film of the lower electrode layer 201 contains oxygen. In the example of the present invention, a plurality of samples were prepared having different concentrations of oxygen in the film of the lower electrode layer 201. More specifically, five samples having an oxygen concentration in the lower electrode layer 201 of 21 at %, 16 at %, 15 at %, 12 at % and 6 at % were prepared as an example of the present invention. In this specification, the five samples are denoted as Sample A, Sample B, Sample C, Sample D and Sample E. The method of varying the oxygen concentration will be described later. The material of the dielectric layer 202 is ZrO₂. The material of the upper electrode layer 203 is Au. The film of the upper electrode layer 203 does not contain oxygen.

The order of preparing the capacitor according to the example of the present invention will be described with using the drawings. Firstly a lower electrode layer 201 was deposited on a substrate. The principal constituent component of the lower electrode layer 201 is TiN. The five samples, that is to say Sample A, Sample B, Sample C, Sample D and Sample E, were prepared as examples of the present invention by varying the film thickness and the method of deposition of the lower electrode layer 201. As methods of depositing the lower electrode layer 201, a PVD method and a CVD method were used. In the samples in which the lower electrode layer 201 was prepared using a PVD method, reactive sputtering was performed using a sputtering target of Ti in a mixed atmosphere of Ar and nitrogen. In the samples in which the lower electrode layer 201 was prepared using a CVD method, TiCl₄ and NH₃ were supplied as synthetic materials and were chemically reacted on the substrate heated to 300° C. The film thicknesses of the lower electrode layers 201 were varied in a range from 10 nm to 100 nm by controlling the film deposition time. The deposition method and film thickness of the respective five samples is as follows. Sample A used a CVD method as a film deposition method for the lower electrode layer 201 and has a film thickness of 20 nm Sample B used a PVD method as a film deposition method for the lower electrode layer 201 and has a film thickness of 100 nm Sample C used a PVD method as a film deposition method for the lower electrode layer 201 and has a film thickness of 50 nm Sample D used a PVD method as a film deposition method for the lower electrode layer 201 and has a film thickness of 20 nm Sample E used a PVD method as a film deposition method for the lower electrode layer 201 and has a film thickness of 10 nm.

Next, the heat processing in a water vapor containing atmosphere after formation of the lower electrode layer 201 will be described. The processing conditions for the heating process after the formation of the lower electrode layer 201 are the same for all five samples. The processing conditions for the heat processing is a partial pressure of water vapor of 2300 Pa, a processing temperature of 28° C. and a processing time of 300 hours.

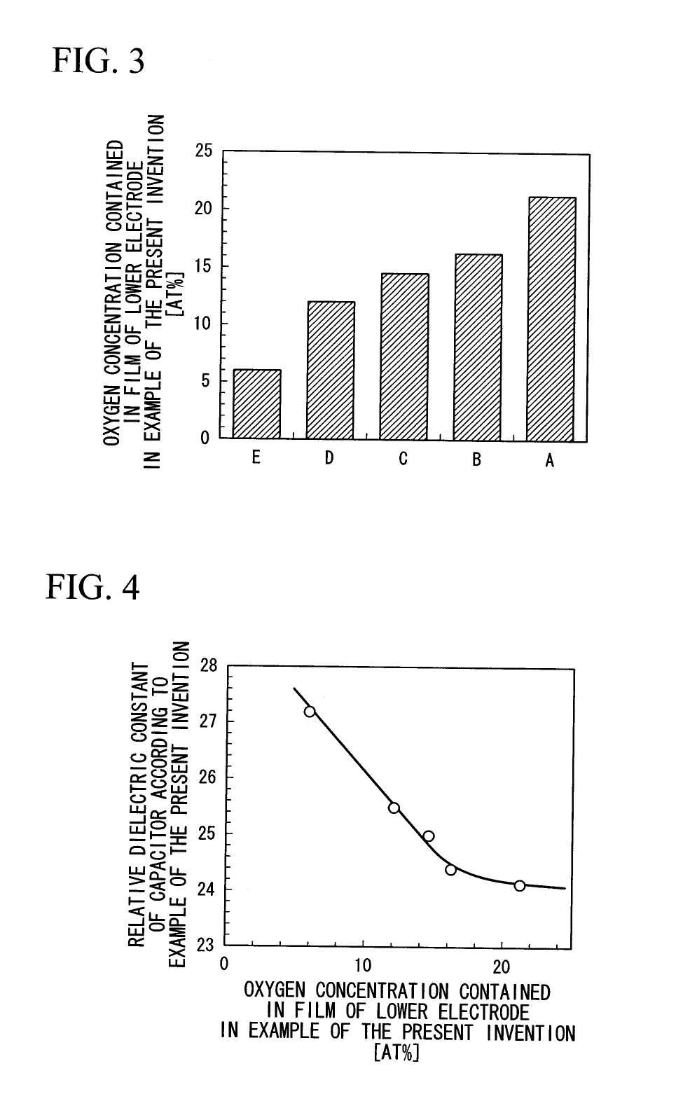

XPS analysis (X-ray photoelectron spectroscopy) was conducted to examine the oxygen concentration contained in the film of the lower electrode layer 201. The oxygen concentration contained in the film of the lower electrode layer 201 in the five types of samples that were examined using XPS analysis coincides with the description above in relation to the structure of the capacitor according to the example of the present invention. FIG. 3 shows the oxygen concentration of the five samples in a graphical format in order to facilitate comprehension. The horizontal axis of FIG. 3 shows the name of the five types of samples. The vertical axis of FIG. 3 shows the respective oxygen concentrations contained to the film of the lower electrode layer 201. In FIG. 3, when the oxygen concentration contained in the films of the lower electrode layer in Sample A and Sample D are compared, the respective oxygen concentrations display considerably different values. From these results, it is shown that when the method of film deposition for forming the lower electrode layer varies, even when the processing conditions for the process of causing oxygen to be contained are the same and the film thickness of the lower electrode layer is the same, the oxygen concentration contained in the film of the lower electrode layer takes a considerable different value. In the same manner, in FIG. 3, when the oxygen concentrations contained in the film in the lower electrode layer of Sample B, Sample C, Sample D and Sample E are compared, when deposition method for the lower electrode layer is the same and the processing conditions for the process of causing oxygen to be contained are the same, it is clear that the oxygen concentration contained in the film of the lower electrode layer increases as the film thickness of the lower electrode layer increases.

Next, the dielectric layer 202 was deposited on an upper portion of the lower electrode layer 201. The material of the dielectric layer 202 as described above is ZrO₂. As a deposition method of the dielectric layer 202, an ALD method was used. TEMAZ and H₂O were supplied as synthetic materials, and these synthetic materials were chemically reacted on a wafer substrate heated to 250° C. in an ALD cycle that repeats, as a single cycle, a deposition sequence in which a TEMAZ introduction step, a TEMAZ discharge step, a H₂O introduction step, a H₂O discharge step were performed in order.

Control of the number of cycles of the ALD cycle enabled variation of the film thickness of the dielectric layer 202 in a range from 3 nm to 10 nm in the respective five types of samples.

Next the capacitor according to the example of the present invention was completed by depositing the upper electrode layer 203 on an upper portion of the dielectric layer 202. The material of the upper electrode layer 203 was Au as described above. The deposition method used for the upper electrode layer 203 was a vacuum deposition method. More specifically, the vacuum deposition method thermally melts and further vaporizes a vapor source of Au in a vacuum using a tungsten filament, and deposits an Au thin film on the wafer. In order to enable measurement of the electrical characteristics of the capacitor, when the upper electrode 203 was deposited, a stainless steel metal mask was used to form the shape of the upper electrode 203 seen from the film surface direction as a circle with a diameter of 120 micrometers.

The respective relative dielectric constant of the five types of samples was obtained by measuring the electrical characteristics of the completed capacitors according the example of the present invention. FIG. 4 shows the measurement results for the electrical characteristics of the capacitors according to the example of the present invention. The horizontal axis of FIG. 4 shows the oxygen concentration in the film of the lower electrode 201 of the five types of samples. The vertical axis of FIG. 4 shows the relative dielectric constant of the respective samples. The method of measuring the electrical characteristics uses a prober and a LCR meter to apply an AC voltage between the lower electrode layer 201 and the upper electrode layer 203 to thereby obtain the electrostatic capacity of the capacitors according to the example of the present invention with an alternating current impedance method. The respective relative dielectric constant of the five samples can be calculated from Equation 1 below using the electrostatic capacity of the capacitor according to the example of the present invention, the surface area of the shape seen from the film surface direction of the upper electrode layer 203 of the capacitor according to the example of the present invention, the film thickness of the dielectric layer 202 of the capacitor according to the example of the present invention, and the relative dielectric constant of vacuum. Here, εr denotes the dielectric constant of the capacitor, C denotes the electrostatic capacity of the capacitor, dr denotes the film thickness of the dielectric layer 202, ε0 denotes the relative dielectric constant of vacuum, and A denotes the surface area of the capacitor. The value for the relative dielectric constant of vacuum is 8.85×10⁻¹² F/m. Separately from the above process, a direct voltage was applied between the lower electrode layer 201 and the upper electrode layer 203, and it was confirmed that the capacitor of the example of the present invention also had a sufficiently low current leakage.

εr=Cdr/ε0A (Equation 1)

From FIG. 4, it is clear that a correlation exists between the relative dielectric constant of the capacitor in the example of the present invention and the oxygen concentration contained in the film of the lower electrode layer according to the example of the present invention. The correlation that exists between the relative dielectric constant of the capacitor in the example of the present invention and the oxygen concentration contained in the film of the lower electrode layer according to the example of the present invention is as follows. When FIG. 4 is examined, it is clear that, when the oxygen concentration contained in the lower electrode layer of the capacitor according to the example of the present invention is less than 21 at %, an effect of the example of the present invention is shown, and that the dielectric constant of the capacitor according to the example of the present invention increases. In the same manner, from FIG. 4, when the oxygen concentration contained in the lower electrode layer of the capacitor according to the example of the present invention is in a range of less than or equal to 16 at %, less than or equal to 15 at %, less than or equal to 12 at %, and less than or equal to 6 at %, it is clear that the effect becomes correspondingly large and the dielectric constant of the capacitor according to the example of the present invention becomes increasingly large.

In XPS analysis, from the information related to the peak position of detected elements, perspective related to the binding state of the detected elements can be also obtained. The XPS analysis in the example of the present invention confirmed that in relation to the binding state of oxygen contained in the film of the lower electrode layer, oxygen binds with titanium (Ti), and at the same time suggests the presence of large amounts of oxygen bound with hydrogen (H). The same analysis was applied to the lower electrode layer of the capacitor of the present invention with respect to which a processing method other than heating process in an atmosphere containing water vapor was applied in relation to the embodiment of the present invention. As a result, the binding state of contained oxygen was the same as when a heating process in an atmosphere containing water vapor was applied. Since titanium is an element that has low electro-negativity and which has properties which facilitate binding with oxygen, it is considered that oxygen bound with titanium has a relatively low reactivity. Therefore, the inventor of the present invention considered that oxygen bound with hydrogen present at higher than a suitable value may be the cause of the problem for which a solution is sought.

There is also the possibility that oxygen bound with hydrogen present at higher than a suitable value may participate in grain boundaries in the film of the lower electrode in the form of H₂O.

This concludes the description of the capacitor according to the example of the present invention.

The present invention can be performed using various structures and methods described in relation to the embodiments of the present invention other than the structure and methods shown by the example of the present invention. Furthermore the technical scope of the present invention is not limited to the above embodiments. The technical scope of the present invention is determined with respect to the scope of the claims. A person ordinarily skilled in the art to which the present invention belongs may employ various modifications within a scope that does not depart from the scope of the present invention. Therefore such modified embodiments also fall within the technical scope of the invention stated described in the claims.

Priority is claimed on Japanese Patent Application 2008-106422 filed in Japan on Apr. 16, 2008, the content which is incorporated herein by reference.

### INDUSTRIAL APPLICABILITY

The present invention can be applied to a capacitor. Use of this capacitor enables an efficient reduction in a current leakage without reducing a relative dielectric constant.

### REFERENCE SYMBOLS

101 Lower electrode layer in the embodiment of the present invention

102 Dielectric layer in the embodiment of the present invention

103 Upper electrode layer in the embodiment of the present invention

201 Lower electrode layer in the example of the present invention

202 Dielectric layer in the example of the present invention

203 Upper electrode layer in the example of the present invention

1. A capacitor comprising a plurality of laminated thin layers, the capacitor having a structure in which a lower electrode layer, a dielectric layer and an upper electrode layer are laminated in sequence, a main material of the lower electrode layer being TiN or ZrN, the lower electrode layer containing oxygen, and concentration of the oxygen contained in the lower electrode layer being less than 21 at %.

2. The capacitor according to claim 1, wherein the concentration of the oxygen contained in the lower electrode layer is less than or equal to 16 at %.

3. The capacitor according to claim 1, wherein the concentration of the oxygen contained in the lower electrode layer is less than or equal to 15 at %.

4. The capacitor according to claim 1, wherein the concentration of the oxygen contained in the lower electrode layer is less than or equal to 12 at %.

5. The capacitor according to claim 1, wherein the concentration of the oxygen contained in the lower electrode layer is less than or equal to 6 at %.

6. The capacitor according to claim 1, wherein the main material used in the lower electrode layer is TiN.

7. The capacitor according to claim 1, wherein a main material of the dielectric layer is any one of ZrO₂, HfO₂, Al₂O₃, ZrAlO, ZrSiO, HfAlO, HfSiO, ZrON, HfON, ZrAlON, ZrSiON, HfAlON, and HfSiON.

8. The capacitor according to claim 1, wherein a main material of the dielectric layer is ZrO₂.

9. A method for manufacturing the capacitor according to claim 1, wherein the dielectric layer is formed by an atomic layer deposition method.

10. The capacitor according to claim 1, wherein the concentration of the oxygen contained in the lower electrode layer is greater than or equal to 6 at %.

11. A capacitor comprising:
a lower electrode layer;
a dielectric layer formed on the lower electrode layer; and
an upper electrode layer formed on the dielectric layer,
wherein a main material of the lower electrode layer is TiN or ZrN, and the lower electrode layer contains oxygen, and concentration of the oxygen contained in the lower electrode layer is less than 21 at %, and
wherein a main material of the dielectric layer is any one of ZrO₂, HfO₂, Al₂O₃, ZrAlO, ZrSiO, HfAlO, HfSiO, ZrON, HfON, ZrAlON, ZrSiON, HfAlON, and HfSiON.

12. The capacitor according to claim 2, wherein the main material used in the lower electrode layer is TiN.

13. The capacitor according to claim 3, wherein the main material used in the lower electrode layer is TiN.

14. The capacitor according to claim 4, wherein the main material used in the lower electrode layer is TiN.

15. The capacitor according to claim 5, wherein the main material used in the lower electrode layer is TiN.

16. The capacitor according to claim 2, wherein a main material of the dielectric layer is any one of ZrO₂, HfO₂, Al₂O₃, ZrAlO, ZrSiO, HfAlO, HfSiO, ZrON, HfON, ZrAlON, ZrSiON, HfAlON, and HfSiON.

17. The capacitor according to claim 3, wherein a main material of the dielectric layer is any one of ZrO₂, HfO₂, Al₂O₃, ZrAlO, ZrSiO, HfAlO, HfSiO, ZrON, HfON, ZrAlON, ZrSiON, HfAlON, and HfSiON.

18. The capacitor according to claim 4, wherein a main material of the dielectric layer is any one of ZrO₂, HfO₂, Al₂O₃, ZrAlO, ZrSiO, HfAlO, HfSiO, ZrON, HfON, ZrAlON, ZrSiON, HfAlON, and HfSiON.

19. The capacitor according to claim 5, wherein a main material of the dielectric layer is any one of ZrO₂, HfO₂, Al₂O₃, ZrAlO, ZrSiO, HfAlO, HfSiO, ZrON, HfON, ZrAlON, ZrSiON, HfAlON, and HfSiON.

20. The capacitor according to claim 6, wherein a main material of the dielectric layer is any one of ZrO₂, HfO₂, Al₂O₃, ZrAlO, ZrSiO, HfAlO, HfSiO, ZrON, HfON, ZrAlON, ZrSiON, HfAlON, and HfSiON.
